(19) United States
(12) Patent Application Publication
(10) Pub. No.: US 2022/0070054 A1
(43) Pub. Date: Mar. 3, 2022

(54) Failure Processing Method and Apparatus, and Storage Medium

(71) Applicant: Suzhou Centec Communications Co., Ltd., Suzhou, Jiangsu (CN)

(72) Inventors: Zhichuan HE, Suzhou, Jiangsu (CN); Jie ZHOU, Suzhou, Jiangsu (CN); Wei GU, Suzhou, Jiangsu (CN); Lei LI, Suzhou, Jiangsu (CN); Wengang WANG, Suzhou, Jiangsu (CN)

(21) Appl. No.: 17/312,407

(22) PCT Filed: Nov. 18, 2019
(86) PCT No.: PCT/CN2019/119195

§ 371 Date: Jun. 10, 2021

(30) Foreign Application Priority Data
Dec. 10, 2018 (CN) 201811504928.8

(51) Int. Cl. H04L 12/24

(52) U.S. Cl. CPC H04L 41/0677

(57) ABSTRACT

Provided are, a failure processing method and apparatus, and a storage medium. The method includes: acquiring a link state detected by a first maintenance end point (MEP) by means of a continuity check message (CCM); and triggering; under a condition that the link state indicates a failure, a second MEP associated with the first MEP to send a customer signal failure (CSF) message.

### CROSS REFERENCE

This application is a National Stage Filing of the PCT International Application No. PCT/CN2019/119195 filed on Dec. 18, 2019, which claims priority to Chinese Application No. 201811504928.8 filed on Dec. 10, 2018, the entirety of which is herein incorporated by reference.

### TECHNICAL FIELD

The present disclosure relates to the field of computers, and particularly relates to a failure processing method and apparatus, and a storage medium.

### BACKGROUND

For the reliability of the network, the operation administration and maintenance (OAM) technology has been widely applied to the access layer, the convergence layer, the core layer of the network. OAM provides a series of functions of failure detection, failure verification and failure location. Two devices deployed with OAM need to be separately provided with maintenance end points (MEPs) for providing a function of failure detection.

It is defined in the ITU-T Y.1731 standard that connectivity between the MEPs is checked by regularly sending a continuity check message (CCM) to each other, and when one MEP does not receive the CCM sent by the other MEP within a certain time, the link is assumed to have failed.

Some devices, which are outside the CCM detection range and do not have the function of link detection, can be informed about the link state by means of a CSF. In an exemplary scenario, an OAM function is deployed between device A and device B, and a link state is detected through the CCM; no OAM function is deployed between device C and device A; and an OAM function is deployed between device B and device C. In this scenario, when the link between device A and device B has a failure, device B can detect this failure and inform device C of this failure through a CSF message, and then device C can know that the link on the other side of device B has a failure so as to take a countermeasure. FIG. 1 is a schematic diagram of a link failure processing mode in the related art. As shown in FIG. 1, a pair of MEPs on device A and device B send CCMs by means of an ASIC chip, and device B sends the CSF message to device C by means of the ASIC chip. When detecting a link failure, MEP1 on device B reports the link failure to CPU, and then the CPU configures MEP2 and sends a CSF message to device C. However, this mode requires CPU intervention, which increases software complexity, and reduces efficiency.

There is currently no effective solution to the above problems in the related art.

### SUMMARY

The embodiments of the present disclosure provide a failure processing method and apparatus, and a storage medium, which may at least solve the problems of higher software complexity and a low efficiency due to the fact that after an MEP on a device detects a link failure, CPU intervention is required for sending a CSF message in the related art.

According to one embodiment of the present disclosure, provided is a failure processing method, including: acquiring a link state detected by a first maintenance end point (MEP) by means of a CCM; and triggering, under a condition that the link state indicates a failure, a second MEP associated with the first MEP to send a CSF message.

In some exemplary implementations of the embodiment, triggering the second MEP associated with the first MEP to send the CSF message includes: determining whether the first MEP is linked with the CSF message; searching, under a condition that the first MEP is linked with the CSF message, an index of the second MEP from a field index of the first MEP; and triggering, after the index of the second MEP is found, the second MEP to send a CSF message

In some exemplary implementations of the embodiment, the method may further include: continuing to execute, under a condition that the link state indicates a failure, the operation of acquiring the link state detected by the first MEP by means of the CCM.

In some exemplary implementations of the embodiment, acquiring the link state detected by the first MEP by means of the CCM includes: periodically acquiring the link state detected by the first MEP by means of the CCM.

In some exemplary implementations of the embodiment, prior to acquiring the link state detected by the first MEP by means of the CCM, the method may further include: establishing an association between the first MEP and the second MEP.

According to another aspect of the embodiments of the present disclosure, provided is a failure processing apparatus, including: an acquisition module, configured to acquire a link state detected by a first MEP by means of a CCM; and a trigger module, configured to trigger, under a condition that the link state indicates a failure, a second MEP associated with the first MEP to send a CSF message.

In some exemplary implementations of the embodiment, the trigger module includes: a determining unit, configured to determine whether the first MEP is linked with the CSF message; a searching unit, configured to search, under a condition that the first MEP is linked with the CSF message, an index of the second MEP from a field index of the first MEP; and a trigger unit, configured to trigger, after the index of the second MEP is found, the second MEP to send the CSF message.

In some exemplary implementations of the embodiment, the acquisition module is further configured to continue to execute, under a condition that the link state indicates a failure, operation of acquiring the link state detected by the first MEP by means of the CCM.

In some exemplary implementations of the embodiment, the acquisition module is further configured to periodically acquire the link state detected by the first MEP by means of the CCM.

In some exemplary implementations of the embodiment, the apparatus may further include: an establishing module, configured to establish, prior to acquiring the link state detected by the first MEP by means of the CCM, an association between the first MEP and the second MEP.

According to yet another aspect of the embodiments of the present disclosure, provided is a storage medium, wherein the storage medium stores a computer program, the computer program being configured to execute the method at runtime.

According to the embodiments of the present disclosure, under a condition that an acquired link state detected by a first MEP by means of a CCM indicates a failure, a second MEP associated with the first MEP is triggered to send a CSF message, so as to avoid triggering a CSF message by CPU intervention in the case of a failure and solve the problems of higher software complexity and a low efficiency due to the fact that after an MEP on a device detects a link failure, CPU intervention is required for sending a CSF message in the related art, thereby improving the efficiency.

### BRIEF DESCRIPTION OF THE DRAWINGS

The accompanying drawings described herein serve to provide a further understanding of the present disclosure and form a part hereof, and the illustrative embodiments of the present disclosure and the description of the illustrative embodiments serve to explain the present disclosure and are not to be construed as unduly limiting the present disclosure. In the drawings:

FIG. 1 is a schematic diagram of a link failure processing mode in the related art;

FIG. 2 is a flowchart of a failure processing method according to an embodiment of the present disclosure;

FIG. 3 is a structural diagram of a failure processing apparatus according to an embodiment of the present disclosure;

FIG. 4 is an exemplary structural diagram of the failure processing apparatus according to the embodiment of the present disclosure.

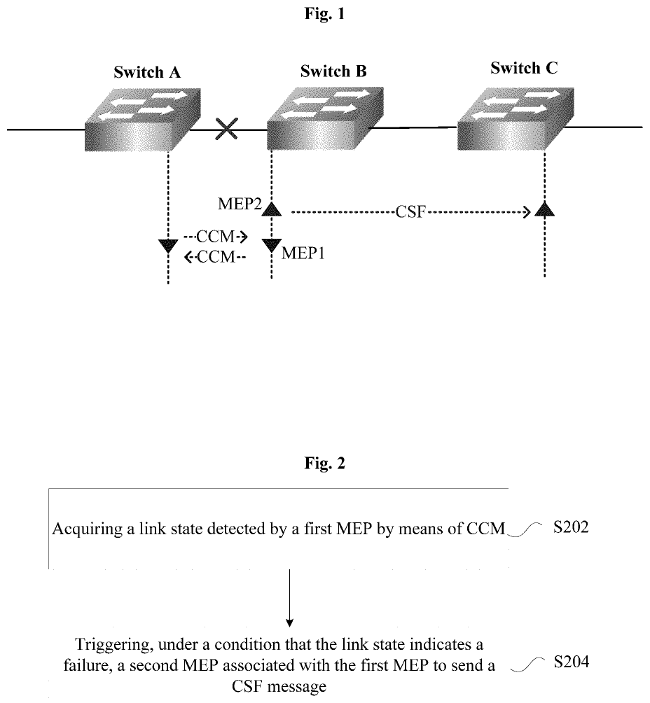

### DETAILED DESCRIPTION OF THE EMBODIMENTS

The present disclosure will be described in detail below with reference to the accompanying drawings in conjunction with embodiments. It should be noted that the embodiments of the present disclosure and the features of the embodiments may be combined with each other without conflict.

It should be noted that the terms “first”, “second”, etc., in the description and claims of the present disclosure and in the above-mentioned drawings, are used to distinguish between similar objects and not necessarily to describe a particular order or sequential order.

### Embodiment 1

Provided in this embodiment is a failure processing method. FIG. 2 is a flowchart of the failure processing method according to the embodiment of the present disclosure. As shown in FIG. 2, the flow includes the following operations:

S202, acquiring a link state detected by a first MEP by means of CCM; and

S204, triggering, under a condition that the link state indicates a failure, a second MEP associated with the first MEP to send a CSF message.

By means of S202 and S204, under a condition that the acquired link state detected by the first MEP by means of the CCM indicates a failure, the second MEP associated with the first MEP is triggered to send a CSF message, so as to avoid triggering a CSF message by CPU intervention in the case of a failure and solve the problems of higher software complexity and a low efficiency due to the fact that after an MEP on a device detects a link failure, CPU intervention is required for sending a CSF message in the related art, thereby improving the efficiency.

In an exemplary implementation of the embodiment, a mode of triggering the second MEP associated with the first MEP to send the CSF message involved in S204 of the embodiment may be implemented by means of the following operations:

S204-11, determining whether the first MEP is linked with the CSF message;

S204-12, searching, under a condition that the first MEP is linked with the CSF message, an index of the second MEP from a field index of the first MEP; and

S204-13, triggering, after the index of the second MEP is found, the second MEP to send a CSF message.

The implementation of the above S204-11 to S204-13 in an exemplary application scenario is described as follows. First, the following fields are defined in the first MEP:

auto_csf_en; //indicates whether CSF is linked; and

csf_mep_index; //indicate an index of the MEP for which a CSF function is configured.

The following field is defined in the second MEP:

csf_en; //indicates a function enabling csf message sending.

Based on the above definition, the process flow of triggering sending of the CSF message is as follows.

The first MEP detects the link state, and under a condition that the link has a failure, whether auto_csf_en is 1 is determined; under a condition that auto_csf_en is 1, information of the second MEP is read according to csf_mep_index; and under a condition that csf_en of the second MEP is 1, a csf message is sent. That is, after the MEP running the CCM detects a link failure, another associated MEP may be directly triggered to directly send the CSF message, which reduces exchange with a CPU, and therefore improves the efficiency.

In another exemplary implementation of the embodiment, the method in the embodiment may further include:

S206, continuing to execute, under a condition that the link state indicates a failure, operation of acquiring the link state detected by the first MEP by means of the CCM.

The operation of acquiring the link state detected by the first MEP by means of the CCM in this embodiment may be: periodically acquiring the link state detected by the first MEP by means of the CCM. The period can be correspondingly set according to a situation, and the specific time value of the period is not limited in the embodiment.

In yet another exemplary implementation of this embodiment, the method of the embodiment includes the operation of: establishing, prior to acquiring the link state detected by the first MEP, an association between the first MEP and the second MEP.

From the description of the above implementations, it will be apparent to those skilled in the art that the methods according to the embodiments described above may be achieved by means of software plus a necessary general-purpose hardware platform, and of course may also be achieved by means of hardware, but in many cases the former is a better implementation. Based on such understanding, the technical solution provided by the present disclosure may be embodied in a form of a software product in essence or a part contributing to the prior art, and the computer software product is stored in a storage medium (such as ROM/RAM, a magnetic disk and an optical disk), and includes a plurality of instructions for enabling a terminal device (such as a mobile phone, a computer, a server or a network device) to execute the method of each embodiment of the present disclosure.

### Embodiment 2

Provided in this embodiment is a failure processing apparatus, the apparatus is used for achieving the embodiment and the exemplary implementation, and the content has been illustrative will not be repeated. The term “module”, as used below, may achieve a combination of software and/or hardware with predetermined functions. While the apparatus described in the following embodiments is preferably achieved in software, implementation of hardware, or a combination of software and hardware, are also possible and conceivable.

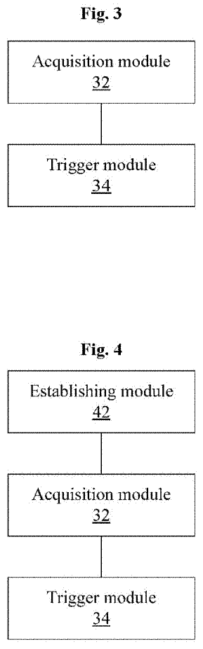

FIG. 3 is a structural diagram of the failure processing apparatus according to the embodiment of the present disclosure. As shown in FIG. 3, the apparatus include: an acquisition module 32, configured to acquire a link state detected by a first MEP by means of a CCM; and a trigger module 34 coupled to the acquisition module 32 and configured to trigger, under a condition that the link state indicates a failure, a second MEP associated with the first MEP to send a CSF message.

In some exemplary implementations of the embodiment, the trigger module 34 involved in the embodiment includes: a determining unit, configured to determine whether the first MEP is linked with the CSF message; a searching unit, configured to search, under a condition that the first MEP is linked with the CSF message, an index of the second MEP from a field index of the first MEP; and a trigger unit, configured to trigger, after the index of the second MEP is found, the second MEP to send the CSF message.

In some exemplary implementations of the embodiment, the acquisition module 32 involved in the embodiment is further configured to continue to execute, under a condition that the link state indicates a failure, the operation of acquiring the link state detected by the first MEP by means of the CCM. The acquisition operation involved in the embodiment may be periodically acquiring the link state detected by the first MEP by means of the CCM.

FIG. 4 is an exemplary structural diagram of the failure processing apparatus according to the embodiment of the present disclosure. As shown in FIG. 4, the apparatus may further include: an establishing module 42, coupled to the acquisition module 32 and configured to establish, prior to acquiring the link state detected by the first MEP by means of the CCM, an association between the first MEP and the second MEP.

It should be noted that the various modules mentioned above may be achieved in software or hardware, achievement in hardware may be implemented as follows but are not limited thereto: the modules mentioned above are located in the same processor; or the modules mentioned above are separately located in different processors in any combination form.

### Embodiment 3

The embodiment of the present disclosure provides a storage medium. In some exemplary implementations of the embodiment, the storage medium described above may be configured to store a program code for executing the following operations:

S1, acquiring a link state detected by a first MEP by means of a CCM; and

S2, triggering, under a condition that the link state indicates a failure, a second MEP associated with the first MEP to send a CSF message.

In some exemplary implementations of the embodiment, the storage medium is further configured to store a program code for executing the following operations:

S1, determining whether the first MEP is linked with the CSF message;

S2, searching, under a condition that the first MEP is linked with the CSF message, an index of the second MEP from a field index of the first MEP; and

S3, triggering, after the index of the second MEP is found, the second MEP to send the CSF message.

In some exemplary implementations of the embodiment, the storage medium described above may include, but is not limited to, a universal serial bus flash disk, a read-only memory (ROM), a random access memory (RAM), a removable hard disk, a magnetic disk, or an optical disk, and various media that may store the program code.

Specific examples in this embodiment may be referred to the examples described in the above-mentioned embodiments and exemplary implementations, which are not described in detail herein.

Obviously, those skilled in the art will appreciate that the modules or operations of the embodiments of the present disclosure mentioned above may be achieved with a general-purpose computation apparatus, and may be centralized on a single computation apparatus or distributed on a network composed of a plurality of computation apparatuses. Optionally, the modules or operations of the embodiments of the present disclosure may be achieved with program codes executable by the computation apparatus, such that they may be stored in a storage apparatus to be executed by the computation apparatus. Under some conditions, the operations shown or described may be executed in an order different from that herein. The modules or operations shown or described may be fabricated separately as individual integrated circuit modules, or multiple modules or operations of them may be fabricated as a single integrated circuit module for achievement. As such, the present disclosure is not limited to any particular combination of hardware and software.

The foregoing is merely the exemplary embodiments of the present disclosure and is not intended to limit the present disclosure, and various changes and modifications may be made by those skilled in the art. Any modifications, equivalent substitutions, improvements, and the like within the spirit and principles of the present disclosure are intended to be included within the scope of protection of the present disclosure.

### INDUSTRIAL APPLICABILITY

In a failure processing process of the present disclosure, under a condition that the acquired link state detected by the first MEP by means of the CCM indicates a failure, the second MEP associated with the first MEP is triggered to send a CSF message, so as to avoid triggering a CSF message by CPU intervention in the case of a failure and solve the problems of higher software complexity and a low efficiency due to the fact that after an MEP on a device detects a link failure, CPU intervention is required for sending a CSF message in the related art, thereby improving the efficiency.

1. A failure processing method, comprising:
acquiring a link state detected by a first maintenance end point (MEP) by means of a continuity check message (CCM); and
triggering, under a condition that the link state indicates a failure, a second MEP associated with the first MEP to send a customer signal failure (CSF) message.

2. The method according to claim 1, wherein triggering the second MEP associated with the first MEP to send the CSF message comprises:
determining whether the first MEP is linked with the CSF message;
searching, under a condition that the first MEP is linked with the CSF message, an index of the second MEP from a field index of the first MEP; and
triggering, after the index of the second MEP is found, the second MEP to send the CSF message.

3. The method according to claim 1, further comprising:
under a condition that the link state indicates a failure, continuing to execute the operation of acquiring the link state detected by the first MEP by means of the CCM.

4. The method according to claim 1, wherein acquiring the link state detected by the first MEP by means of the CCM comprises:
periodically acquiring the link state detected by the first MEP by means of the CCM.

5. The method according to claim 1, wherein prior to acquiring the link state detected by the first MEP by means of the CCM, the method further comprises:
establishing an association between the first MEP and the second MEP.

6. A failure processing apparatus, comprising a memory storing instructions and a processor in communication with the memory, wherein the processor is configured to execute the instructions to:
acquire a link state detected by a first maintenance end point (MEP) by means of a continuity check message (CCM); and
trigger, under a condition that the link state indicates a failure, a second MEP associated with the first MEP to send a customer signal failure (CSF) message.

7. The apparatus according to claim 6, wherein the processor, when being configured to execute the instructions to trigger, under the condition that the link state indicates the failure, the second MEP associated with the first MEP to send the CSF message, is configured to:
determine whether the first MEP is linked with the CSF message;
search, under a condition that the first MEP is linked with the CSF message, an index of the second MEP from a field index of the first MEP; and
trigger, after the index of the second MEP is found, the second MEP to send a CSF message.

8. The apparatus according to claim 6, wherein the processor is further configured to execute the instructions to
continue to execute, under a condition that the link state indicates a failure, the operation of acquiring the link state detected by the first MEP by means of the CCM.

9. The apparatus according to claim 6, wherein the processor is further configured to execute the instructions to periodically acquire the link state detected by the first MEP by means of the CCM.

10. The apparatus according to claim 6, wherein the processor is further configured to execute the instructions to:
establish, prior to acquiring the link state detected by the first MEP by means of the CCM, an association between the first MEP and the second MEP.

11. A non-transitory computer-readable storage medium, wherein the storage medium stores a computer program, the computer program being configured to execute the method according to claim 1 at runtime.

12. The method according to claim 2, wherein a first field for indicating whether CSF is linked is defined in the first MEP, and determining whether the first MEP is linked with the CSF message comprises:
determining whether the first MEP is linked with the CSF message according to the first field, wherein in a case where the first field indicates that the CSF is linked, it is determined that the first MEP is linked with the CSF message; otherwise, it is determined that the first MEP is not linked with the CSF message.

13. The method according to claim 2, wherein a second field for indicating the index of the second MEP for which a CSF function is configured is defined in the first MEP, and searching the index of the second MEP from the field index of the first MEP comprises:
reading the index of the second MEP according to the second field of the first MEP.

14. The method according to claim 2, wherein a field for indicating a function enabling CSF message sending is defined in the second MEP, and triggering the second MEP to send the CSF message comprises:
triggering the second MEP to send the CSF message under a condition that the field of the second MEP indicates the function enabling CSF message.

15. The method according to claim 3, wherein acquiring the link state detected by the first MEP by means of the CCM comprises:
periodically acquiring the link state detected by the first MEP by means of the CCM.

16. The method according to claim 2, wherein prior to acquiring the link state detected by the first MEP by means of the CCM, the method further comprises:
establishing an association between the first MEP and the second MEP.

17. The method according to claim 3, wherein prior to acquiring the link state detected by the first MEP by means of the CCM, the method further comprises:
establishing an association between the first MEP and the second MEP.

18. The apparatus according to claim 8, wherein the processor is further configured to execute the instructions to periodically acquire the link state detected by the first MEP by means of the CCM.

19. The apparatus according to claim 7, wherein the processor is further configured to execute the instructions to:
establish, prior to acquiring the link state detected by the first MEP by means of the CCM, an association between the first MEP and the second MEP.

20. The apparatus according to claim 8, wherein the processor is further configured to execute the instructions to:
establish, prior to acquiring the link state detected by the first MEP by means of the CCM, an association between the first MEP and the second MEP.
